(19) United States
(12) Patent Application Publication
(10) Pub. No.: US 2017/0004521 A1
(43) Pub. Date: Jan. 5, 2017

(54) SYSTEMS AND METHODS FOR GENERATING INDUSTRY OUTLOOK SCORES

(71) Applicant: Prevedere, Inc, Columbus, OH (US)

(72) Inventors: Richard Wagner, Columbus, OH (US); Andrew Duguay, Columbus, OH (US)

(21) Appl. No.: 15/197,669

(22) Filed: Jun. 29, 2016

Related U.S. Application Data
(63) Continuation-in-part of application No. 13/558,333, filed on Jul. 25, 2012.
Application No. 13/558,333 is a continuation-in-part of application No. 15/154,697, filed on May 13, 2016.
(60) Provisional application No. 62/269,978, filed on Dec. 19, 2015.
(60) Provisional application No. 62/290,441, filed on Feb. 2, 2016.
(60) Provisional application No. 61/511,527, filed on Jul. 25, 2011.
(60) Provisional application No. 61/512,405, filed on Jul. 28, 2011.

(51) Int. Cl. G06Q 30/02; G06Q 40/06

(52) U.S. Cl. CPC G06Q 30/0206; G06Q 30/0201; G06Q 40/06

(57) ABSTRACT

The present invention relates to systems and methods for the generation of industry outlook scores. Datasets that are factors for the industry being scored are collected. These datasets are then normalized and then transformed into the outlook score. Lastly, the resulting outlook score may be characterized, compared to prior scores to identify trends, and displayed to the user. The characterization may include grouping scores into quartiles and color coding the scores accordingly.

### CROSS REFERENCE TO RELATED APPLICATIONS

The present application claims priority to a commonly-owned application entitled “Systems and Methods for Analyzing Time Series Data to Extract and Display Statistical Relationships Between Data Series”, U.S. Provisional Application No. 62/269,978, filed on Dec. 19, 2015, which is incorporated herein by reference for all purposes.

The present application also claims priority to a commonly-owned application entitled “Systems and Methods for Analyzing Time Series Data to Extract and Display Statistical Relationships Between Data Series”, U.S. Provisional Application No. 62/290,441, filed on Feb. 2, 2016, which is incorporated herein by reference for all purposes.

The present application additionally is a continuation-in-part and claims priority to a commonly-owned application entitled “Interactive Chart Utilizing Shifting Control to Render Shifting of Time Domains of Data Series”, U.S. application Ser. No. 13/558,333, filed on Jul. 25, 2012, which claims priority to U.S. Provisional Application 61/511,527, filed Jul. 25, 2011 and U.S. Provisional Application 61/512,405, filed Jul. 28, 2011, which applications are incorporated herein by reference for all purposes.

The present application also is a continuation-in-part and claims priority to a commonly-owned application entitled “Systems and Methods for Forecasting Based Upon Time Series Data”, U.S. application Ser. No. 15/154,697, filed on May 13, 2016, which is incorporated herein by reference for all purposes.

### BACKGROUND

The present invention relates to systems and methods for the generation of industry outlook scores. These outlook scores enable effortless and improved insight into the current and future state of industries. These metrics are very useful to business decision makers, investors and operations experts.

Many factors influence the success or failure of a business or other organization. Many of these factors include controllable variables, such as product development, talent acquisition and retention, and securing business deals. However, a significant amount of the variables influencing a business' success are external to the organization. These external factors that influence an organization are typically entirely out of control of the organization, and are often poorly understood or accounted for during business planning. Generally, one of the most difficult variables for a business to account for is the general health of a given business sector.

While these external factors are not necessarily able to be altered, being able to incorporate them into business planning allows a business to better understand the impact on the business, and make strategic decisions that take into account these external factors. This may result in improved business performance, investing decisions, and operational efficiency. However, it has traditionally been very difficult to properly account for, or model, these external factors; let alone generate meaningful forecasts using many different factors in a statistically meaningful and user friendly way.

For example, many industry outlooks that current exist are merely opinions of so-called “experts” that may identify one or two factors that impact the industry. While these expert forecasts of industry health have value, they provide a very limited, and often inaccurate, perspective into the industry. Further these forecasts are generally provided in a qualitative format, rather than as a quantitative measure. For example, the housing industry may be considered “healthy” if the prior year demand was strong and the number of housing starts is up. However, the degree of ‘health’ in the market versus a prior period is not necessarily available of well defined.

As a result, current analytical methods are incomplete, not quantitative, time consuming and labor intensive processes that are inadequate for today's competitive, complex and constantly evolving business landscape.

It is therefore apparent that an urgent need exists for organizational solutions that enable the generation of industry outlook scores. These systems and methods for generating industry outlook scores enables better business and investment functioning.

### SUMMARY

To achieve the foregoing and in accordance with the present invention, systems and methods for generating industry outlook scores are provided. Such systems and methods enable business persons, investors, and industry strategists to better understand the present state of their industries, and more importantly, to have foresight into the future state of their industry.

In some embodiments, the initial step is to isolate the datasets that are factors for the industry being scored. These datasets are then normalized by smoothing volatility from the elected datasets, aligning the datasets by similar dates, classifying the datasets as normal, inverted or diffusion, determining month-to-month change of each dataset based upon the classification, and adjusting to equalize volatility between datasets. The smoothing volatility from the elected datasets may utilize a Hodrick Prescott filter. The normal classified datasets are procyclic to the index, the inverse classified datasets are counter-cyclic to the index, and the diffusion classified datasets are measures of the proportion of the dataset that are positive impacts on the index.

Subsequently the outlook score can be generated by generating a growth rate index, summing the growth rates to equate trends to a coincidence index, computing an index with a symmetric percent change formula, rebasing the index to average 100, converting the index to a three period year over year percent change, and converting the three period year over year percent change to a normalized scale. Converting the three period year over year percent change to the normalized scale includes setting the minimum value of the three period year over year percent change to zero and the maximum value of the three period year over year percent change to 1000 on a linear scale.

Lastly, the resulting outlook score may be characterized, compared to prior scores to identify trends and be displayed to the user. The characterization may include grouping scores into quartiles and color coding the scores accordingly.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1A is an example logical diagram of a data management system for generating industry outlook scores, in accordance with some embodiments;

FIG. 1B is a second example logical diagram of a data management system for generating industry outlook scores, in accordance with some embodiments;

FIG. 2 is an example logical diagram of an application server, in accordance with some embodiments;

FIG. 3 is a flow chart diagram of an example high level process for forecasting utilizing time series datasets, in accordance with some embodiments;

FIG. 4 is a flow chart diagram of an example high level process for the generation of composites, in accordance with some embodiments;

FIG. 5A-C are flow chart diagrams of an example processes for the generation of the forecasts, in accordance with some embodiments;

FIG. 6 is a flow chart diagram of an example process for the analysis of the forecasts, in accordance with some embodiments;

FIG. 7 is a flow chart diagram of an example process for the generation of industry outlook scores, in accordance with some embodiments;

FIGS. 8-10 are example screenshots illustrating the industry outlook score interfaces, in accordance with some embodiments; and

FIGS. 11A and 11B illustrate exemplary computer systems capable of implementing embodiments of the data management and forecasting system.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “only,” “first,” “initially,” “next,” “subsequently,” “before,” “after,” “lastly,” and “finally,” are not meant to limit the scope of the present invention as the embodiments disclosed herein are merely exemplary.

Note that significant portions of this disclosure will focus on the generation of industry outlook scores for businesses. While this is intended as a common use case, it should be understood that the presently disclosed systems and methods are useful for the generation of any industry outlook scores based upon any time series data sets, for consumption by any kind of user. For example, the presently disclosed systems and methods could be relied upon by a researcher to predict trends as easily as it is used by a business to forecast sales trends. As such, any time the term ‘business’ is used in the context of this disclosure it should be understood that this may extend to any organization type: individual, investor group, business entity, governmental group, non-profit, religious affiliation, research institution, and the like. Further, references to an industry outlook score should be understood to not be limited to commerce, but rather to any situation where an outlook score may be needed or desired.

Lastly, note that the following description will be provided in a series of subsections for clarification purposes. These following subsections are not intended to artificially limit the scope of the disclosure, and as such any portion of one section should be understood to apply, if desired, to another section.

### I. DATA MANAGEMENT SYSTEMS FOR GENERATION OF INDUSTRY OUTLOOK SCORES

The present invention relates to systems and methods for using available data and metrics to generate an entirely new data set through transformations to yield industry outlook scores. While various indices are already known, the presently disclosed systems and methods provide a score that is forward looking rather than providing merely a snapshot of the current situation. Further, the industry outlook scores are generated in such a fashion that the score value is normalized regardless of what industry is being compared. Thus a score of 600 for business to business (B2B) industry sector would indicate the same degree of health as a score of 600 in the construction sector, despite the very different underlying data. Such systems and methods allow for superior insight into current and near future health of a given industry sector. This enables for better business planning, preparation, investment, and generally may assist in influencing behaviors in more profitable ways.

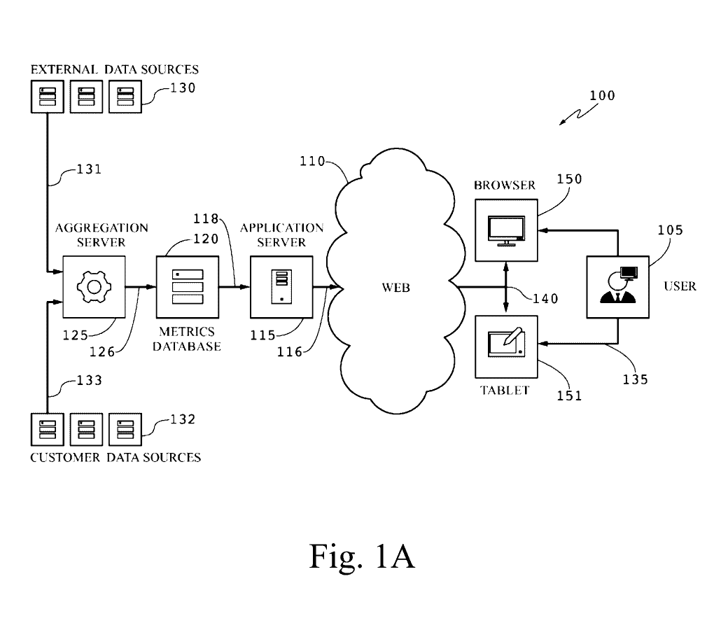

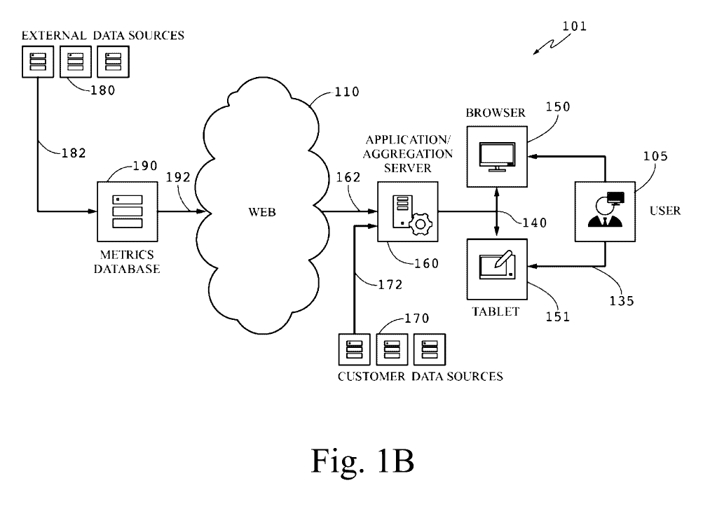

To facilitate discussion, FIG. 1A is an example logical diagram of a data management system for generation of industry outlook scores 100. The data analysis system 100 connects a given analyst user 105 through a network 110 to the system application server 115. A database 120 (or other suitable dataset based upon forecast sought) is linked to the system application server via connection 121 and the database 120 thus provides access to the data necessary for utilization by the application server 115.

The database 120 is populated with data delivered by and through the data aggregation server 125 via connection 126. Data aggregation server 125 is configured to have access to a number of data sources, for instance external data sources 130 through connection 131. The data aggregation server can also be configured to have access to proprietary or internal data sources, i.e. customer data sources 132, through connection 133. The aggregated data may be stored in a relational database (RDBM) or in big data-related storage facilities (e.g., Hadoop, NoSQL), with its formatting pre-processed to some degree (if desired) to conform to the data format requirement of the analysis component.

Network 110 provides access to the user or data analyst (the user analyst). User analyst 105 will typically access the system through an internet browser, such as Mozilla Firefox, or a standalone application, such as an app on tablet 151. As such, the user analyst (as shown by arrow 135) may use an internet connected device such as browser terminal 150, whether a personal computer, mainframe computer, or VT100 emulating terminal. Alternatively, mobile devices such as a tablet computer 151, smart telephone, or wirelessly connected laptop, whether operated over the internet or other digital telecommunications networks, such as a 3G network. In any implementation, a data connection 140 is established between the terminal (i.e., 150 or 151) through network 110 to the application server 115 through connection 116.

Network 110 is depicted as a network cloud and as such is representative of a wide variety of telecommunications networks, for instance the world wide web, the internet, secure data networks, such as those provided by financial institutions or government entities such as the Department of Treasury or Department of Commerce, internal networks such as local Ethernet networks or intranets, direct connections by fiber optic networks, analog telephone networks, through satellite transmission, or through any combination thereof.

The database 120 serves as an online available database repository for collected data including such data as internal metrics. Internal metrics can be comprised of, for instance, company financial data of a company or other entity, or data derived from proprietary subscription sources. Economic, demographic, and statistical data that are collected from various sources and stored in a relational database, may reside in a local hardware set or within a company intranet, or may be hosted and maintained by a third-party and made accessible via the internet.

The application server 115 provides access to a system that provides a set of calculations based on system formula used to calculate the leading, lagging, coincident, procyclic, acyclic, and counter-cyclic nature of economic, demographic, or statistical data compared to internal metrics, i.e., company financial results, or other external metrics. The system also provides for formula that may be used to calculate a plurality of industry outlook scores based on projected or actual economic, demographic, and statistical data and company financial or sold volume or quantity data. Details of the formulas and processes utilized for the calculation of these industry outlook scores shall be provided in further detail below. These calculations can be displayed by the system in chart or other graphical format.

In some embodiments, changes observed in a metric may also be classified according to its direction of change relative to the indicator that it is being measured against. When the metric changes in the same direction as the indicator, the relationship is said to be ‘procyclic’. When the change is in the opposite direction as the indicator, the relationship is said to be ‘countercyclic’. Because it is rare that any two metrics will be fully procyclic or countercyclic, it is also possible that a metric and an indicator can be acyclic—i.e., the metric exhibits both procyclic and countercyclic movement with respect to the indicator.

The application residing on server 115 is provided access to interact with the customer datasource(s) 132 through the database 120 to perform automatic calculations which identify leading, lagging, and coincident indicators as well as the procyclic, acyclic, and countercyclic relationships between customer data and the available economic, demographic, and statistical data. Additionally, the industry outlook scores may be automatically populated on a periodic schedule, i.e. every month. Users 105 of the software applications that can be made available on the application server 115 are able to select and view charts or monitor dashboard modules displaying the results of the calculations performed by the system. In some embodiments, user 105 can select data in the customer repository for use in the calculations that may allow the user to forecast future performance, or tune the industry outlook scores. The types of indicators and internal data are discussed in more detail in connection with the discourse accompanying the following figures. Alternatively, users can view external economic, demographic, and statistical data only and do not have to interface with internal results, at the option of the user. In yet other embodiments, all internal and external data may be shielded from the user, and only the resulting industry outlook scores is provided to the user for ease of use.

Data is collected for external indicators and internal metrics of a company through the data aggregation server 125. The formulas built into the application identify relationships between the data. Users 105 can then use the charting components to view the results of the calculations and industry outlook scores. In some embodiments, the data can be entered into the database 120 manually, as opposed to utilizing the data aggregation server 125 and interface for calculation and forecasting. In some embodiments, the users 105 can enter and view any type of data and use the applications to view charts and graphs of the data.

Alternatively, in some system users may have sensitive data that requires it to be maintained within the corporate environment. FIG. 1B depicts components of the system in an exemplary configuration to achieve enhanced data security and internal accessibility while maintaining the usefulness of the system and methods disclosed herein. For example, the data management system 101 may be configured in such a manner so that the application and aggregation server functions described in connection with FIG. 1A are provided by one or more internal application/aggregation servers 160. The internal server 160 access external data sources 180 through metrics database 190, which may have its own aggregation implementation as well. The internal server accesses the metrics database 190 through the web or other such network 110 via connections 162 and 192. The metrics database 190 acquires the appropriate data sets from one or more external sources, as at 180, through connection 182.

The one or more customer data sources 170 may be continue to be housed internally and securely within the internal network. The internal server 160 access the various internal sources 170 via connection 172, and implements the same type of aggregation techniques described above. The user 105 of the system then accesses the application server 160 with a tablet 151 or other browser software 150 via connections 135 and 140, as in FIG. 1A. External data sources 130 and 180 may be commercial data subscriptions, public data sources, or data entered into an accessible form manually.

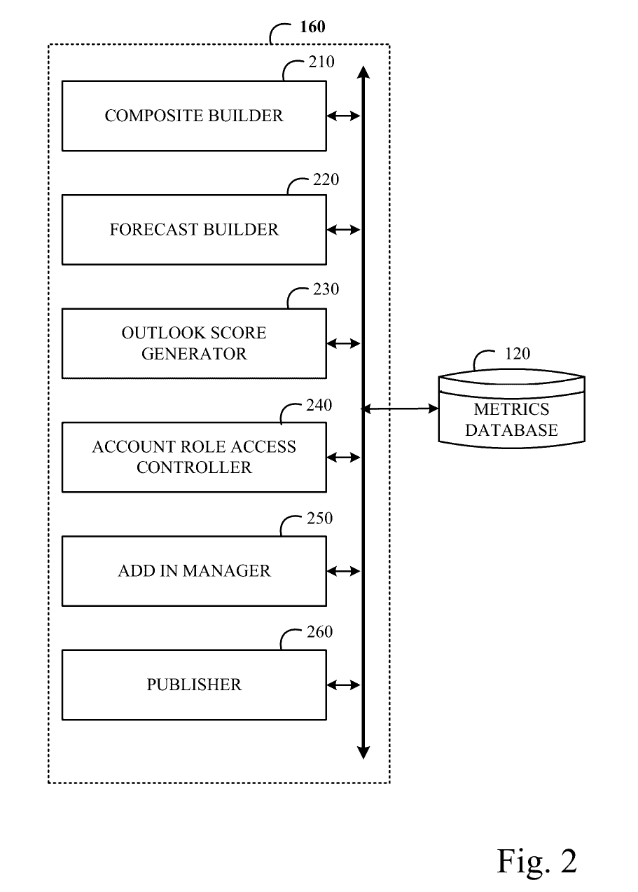

FIG. 2 is an example logical diagram of an application server 160 that includes various subcomponents that act in concert to enable a number of functions, including the generation of composites, forecasts and, central to this disclosure, industry outlook scores. Generally the data being leveraged for the generation of industry outlook scores includes economic, demographic, geopolitical, public record and statistical data. In some embodiments, the system utilizes any time series dataset. This time series data stored in the metrics database 120, is available to all subsystems of the application server 160 for manipulation, transformation, aggregation, and analysis.

The subcomponents of the application server 160 are illustrated as unique modules within the server coupled by a common bus. While this embodiment is useful for clarification purposes, it should be understood that the presently discussed application server may consist of logical subcomponents operating within a single or distributed computing architecture, may include individual and dedicated hardware for each of the enumerated subcomponents, may include hard coded firmware devices within a server architecture, or any permutation of the embodiments described above. Further, it should be understood that the listed subcomponents are not an exhaustive listing of the functionality of the application server 160, and as such more or fewer than the listed subcomponents could exist in any given embodiment of the application server when deployed.

The application server 160 includes a composite builder 210 that is capable of combining various metrics from the metric database 120 (also referred to as factors or indicators), and manipulate them in order to generate composite indexes. These composites enable are entirely new datasets generated by transforming one or more existing datasets. The composite builder 210 also has the ability to assign access controls to the composites (to ensure organizational security and protection of intellectual property), and automatically update the composites as updated underlying data becomes available. In addition to providing useful tools user-friendly interfaces for searching, compiling and transforming the indicators, the composite builder 210 may provide suggestions to a user for inclusion of particular indicator data and possible manipulations based upon data type and statistical measures.

The application server 160 also includes a forecast builder 220. The forecast builder's 220 functionality shall be discussed in considerable details below; however, at its root it allows for the advanced compilation of many indicators (including other published composite metrics and forecasts) and enables unique manipulation of these datasets in order to generate forecasts from any time series datasets. Some of the manipulations enabled by the forecast builder are the ability to visualize, on the fly, the R², procyclic and countercyclic values for each indicator compared to the forecast, and further allows for the locking of any indicators time domain, and to shift other indicators and automatically update statistical measures. Additionally, the forecast builder 220 may provide the user suggestions of suitable indicators, and manipulations to indicators to ensure a ‘best’ fit between prior actuals and the forecast over the same time period. The ‘best’ fit may include a localized maxima optimization of weighted statistical measures. For example, the R², procyclic and countercyclic values could each be assigned a multiplier and the time domain offset used for any given indicator could be optimized for accordingly. The multipliers/weights could, in some embodiments, be user defined.

Continuing, the application server 160 also includes an industry outlook score generator 230. The industry outlook score generator 230 is essentially a specialized composite builder that is not subject to the user manipulation that the composite builder 210 includes. The reason for this limitation of user customization is to maintain the normalization between the scores generated between the various industry sectors. As previously noted, a score of a given number in one industry can be directly compared to the numerical score in another industry sector. Despite the very different underlying data sources, and differences in the industries themselves, the industry outlook scores are dimensionless and provide a raw measure of an industries expected health over a relatively short timeframe.

In some embodiments, the industry outlook scores may range between 0 and 1000, and may indicate the health of the industry over the next six months. In alternate embodiments, the industry outlook scores may be normalized for a different value range, from 0 to 100 for example. Likewise, the underlying data and weights afforded to each data type may be modified to alter the time period over which the industry outlook score is providing a measure.

In some embodiments, the industry outlook scores may be calculated using a generic macro equation. In some embodiments, the factors used for the calculation of the outlook score are collected and a Hodrick Prescott filter is applied in order to reduce month-to-month volatility. The Hodrick Prescott filter may take the form of:

xₜ=gₜ+cₜ

Where xₜ is the original series composed of a trend component (gₜ) and a cyclical component (cₜ). The Hodrick Prescott filter isolates the cycle component by the following minimization problem:

$${\sum }_{t = 1}^{T} {( {x}_{t} - {g}_{t} )}^{2} + λ {\sum }_{t = 1}^{T - 1} {[ [ {( g ]}_{t - 1} - {g}_{t} ) - ( {g}_{t} - {g}_{t - 1} ) ]}^{2}$$

The first term of the above equation is a measure of fitness of the tie series while the second term is a measure of smoothness. The λ, is a “trade off” parameter for balancing the fitness to smoothness. At λ, being zero, the trend is equivalent to the original series, and as it increases the trend approaches linear. In some embodiments, a factor of 50, 75, 100, 125, 150 or 175 is utilized for the term λ. It should be understood that other volatility reduction techniques may be employed in alternate embodiments.

After smoothing the datasets, they may be all aligned by date. Next each indicator is assigned an identifier. These identifiers include a “normal” identification for procyclic indicators, an “inverse” identification for counter cyclic indicators, and “diffusion” identification for indicators that are diffusion indexes. Diffusion indexes measure the proportion of the components that contribute positively to the index. Components are each sorted by how much they change, and are assigned a value accordingly. In some embodiments, components that rise more than 0.05 percent are given a value of 1, components that change less than 0.05 percent are given a value of 0.5, and components that fall more than 0.05 percent are given a value of 0. The value of the components is summed, divided by the total number of components (averaged) and multiplied by 100 to result in a percentage.

After applying identifiers to the components, the month-to-month change for each component is computed. For a ‘normal’ component x, this calculation may take the form of:

$$x ( t ) = 200 \frac{( {x}_{t} - {x}_{t - 1} )}{( {x}_{t} + {x}_{t - 1} )}$$

For an ‘inverse’ component x, this equation may take the form of:

$$x ( t ) = 200 \frac{( {x}_{t - 1} - {x}_{t} )}{( {x}_{t} + {x}_{t - 1} )}$$

Lastly, for a ‘diffusion’ component the monthly level is used for the month-to-month change as these indexes are already normalized by subtracting their sample mean and dividing by their standard deviation.

After computing the month-to-month changes, the standard deviation vₓ of the changes for each component are calculated. The standard deviation is inverted

$$\frac{1}{{v}_{x}}$$

and the sum k calculated by:

$$k = \sum \frac{1}{{v}_{x}} .$$

The sum is restated so that the index's component standardization factors sum to one, as shown here:

$${r}_{x} = \frac{1}{k} \times \frac{1}{{v}_{k}} .$$

The adjusted contribution mₜ in each component is the monthly contribution multiplied by the corresponding component standardization factor, as illustrated in this equation:

m_{z}=rₓ×xₜ

The adjusted contribution mₜ is added across all the components for each month to obtain a growth rate iₜ of the index, as shown by: iₜ=Σm_{x,t}. The sum of the growth rates for all the components of the outlook score are then adjusted to equate their trends to that of the coincidence index. This is accomplished by applying an adjustment factor α to the growth rates of the index each month, as shown:

i′ₜ=iₜ+α

Subsequently, the index level is computed using a symmetric percent change formula. This computation may include a recursive calculation starting from an initial value of 100 for the first month of the sample period, such that the value is calculated as:

$${I}_{n + 1} = {I}_{n} \times \frac{200 + {i}_{n + 1}^{′}}{200 - {i}_{n + 1}^{′}}$$

Next the index is multiplied by 100 and divided by the average value of the twelve months of the based year. Then the index is converted to a three period year over year percent change value. This is calculated by calculating a three month rolling sum of the above calculated index divided by the same period one year prior.

Lastly, the growth rate is converted to the appropriate scale. In some embodiment, this includes converting to a 0-1000 point scale. This may be achieved by a simple linear equation where the minimum growth rate is equivalent to 0 and the maximum rate is equivalent to 1000.

The industries for which an outlook score may include, by way of example, automotive sales, business to business (B2B) services, business to consumer (B2C) services, chemical manufacture, construction of non-residential structures, construction of residential structures, industrial production, restaurants, retail, steel, telecommunications, healthcare, hospitality, tourism, durable goods manufacturing, and the like. It should be understood that this is not by any means an exhaustive listing of the various industry segments for which an outlook score may be generated. Further it should be understood that any of these industries may be further sub-segmented by region, category or brand, in some embodiments. For example, the auto sales industry may be refined to illustrate only sales of light trucks in the northeast of the US for a particular user.

The factors and underlying data utilized to generate each of the outlook scores may vary considerably, in some embodiments, based upon the industry segment. For example, for the automotive industry sector, the factors utilized to generate the outlook score may include residential architectural billings index, consumer sentiment scores, ISM manufacturing index of new orders, Moody's Seasoned Aaa Corporate bond yield, personal savings rate and consumer price index for urban consumers. In contrast, B2B service sector may rely upon commercial architectural billings index, Cass Freight index of expenditures, economic policy uncertainty index for the United States, NFIB small business optimism index, United States Non-Manufacturing Business Tendency Survey: Business Situation and Activity, and an adjusted S&P 500 score. The factors for B2C services may include ISM manufacturing index of new orders, personal savings rate and consumer confidence index. Chemicals industry sectors may depend upon industrial production and capacity utilization rate for chemicals, architectural billings index for new projects inquiries, ISM manufacturing index of new orders, real average hourly earnings, producer price index for chemical manufacturing, an adjusted materials select sector index, S&P Case-Shiller 10-City home price sales pair count, and the average weekly hours of production employees in the chemical sector. For the consumer packaged goods sector, the factors relied upon include ISM PMI composite, consumer sentiment, an adjusted J&J stock price, and the S&P Case-Shiller 10-City home sales arima 2. For the outlook for the GDP, the factors relied upon include Prevedere retail leading indicator composite, Prevedere industrial production leading indicator composite, Prevedere residential construction leading indicator composite, NFIB small business optimism index, Bank of America Merrill Lynch US corporate AAA option adjusted spread, and ISM manufacturing PMI composite index. For the outlook of industrial production, the factors relied upon include ISM manufacturing PMI composite index, architectural billings index for new projects inquiries, consumer sentiment scores, real personal consumption expenditures for durable goods, and an adjusted score of American Express Company stock price. For the outlook of non-residential construction, the factors relied upon include value of manufacturers' new orders for durable goods for the electrical equipment industry, total business sales, commercial paper outstanding, and construction employment. For the outlook for residential construction, the factors relied upon may include S&P Case-Shiller 20-City home price sales pair count, new homes sold in the United States, consumer sentiment, assets and liabilities of commercial banks in the United States, forecasts of non-farm job openings, and agricultural billings index for residential. The outlook for the restaurant sector may rely upon factors such as real disposable personal income, food service spread, Prevedere retail leading indicator composite, and adjusted consumer discrete select sector SPDR. For the retail industry outlook the factors that may be relied upon may include personal savings rates, consumer sentiment, the S&P 500, a volatility measure of the S&P 500, agricultural billings index for residential, ISM manufacturing index of new orders, and real average hourly earnings. For the steel industry outlook score, the factors relied upon may include ISM manufacturing index of new orders, non-branch merchant wholesalers durable goods inventory to sales ratio, architectural billings index for new projects inquiries, an adjusted United States Steel Corporation stock price, and the value of manufacturers' new orders for durable goods for iron and steel mills. For the telecom industry outlook score, the factors relied upon may include the Prevedere industrial production leading indicator composite, personal savings rate, and the value of manufacturers' new orders for the communication equipment industries.

Returning to FIG. 2, the application server 160 also includes an access controller 240 to protect various data from improper access. Even within an organization, it may be desirable for various employees or agents to have split access to various sensitive data sources, forecasts or models. Further, within a service or consulting organization, it is very important to separate various clients' data, and role access control enables this data from being improperly comingled.

An add-in manager 250 provides add-in application interfaces (APIs), emails, XLS and/or via subscriptions in order to export data for various external systems. For example the system may include Microsoft Excel®, SAP® and similar extensions for outputting raw data sets, forecast calculations and models.

Lastly, a publisher 260 allows for the composites generated by the composite builder 210, and forecasts generated via the forecast builder 220 and the outlook scores generated by the industry outlook score generator to be published, with appropriate access controls, for visualization and manipulation by the users.

By automating an otherwise time-consuming and labor-intensive process, the above-described data management system for generating industry outlook scores offers many advantages, including the normalization of a score that may be utilized to compare industries current condition, forward looking condition, and the ability to directly compare the condition of different industry types. In addition, the application server no longer requires user expertise. The result is substantially reduced user effort needed for the generation of timely and accurate outlook scores.

Now that the systems for data management for generating industry outlook scores have been described in considerable detail, attention will be turned towards methods of operation in the following subsection.

### II. DATA MANAGEMENT AND OUTLOOK SCORE GENERATION METHODS

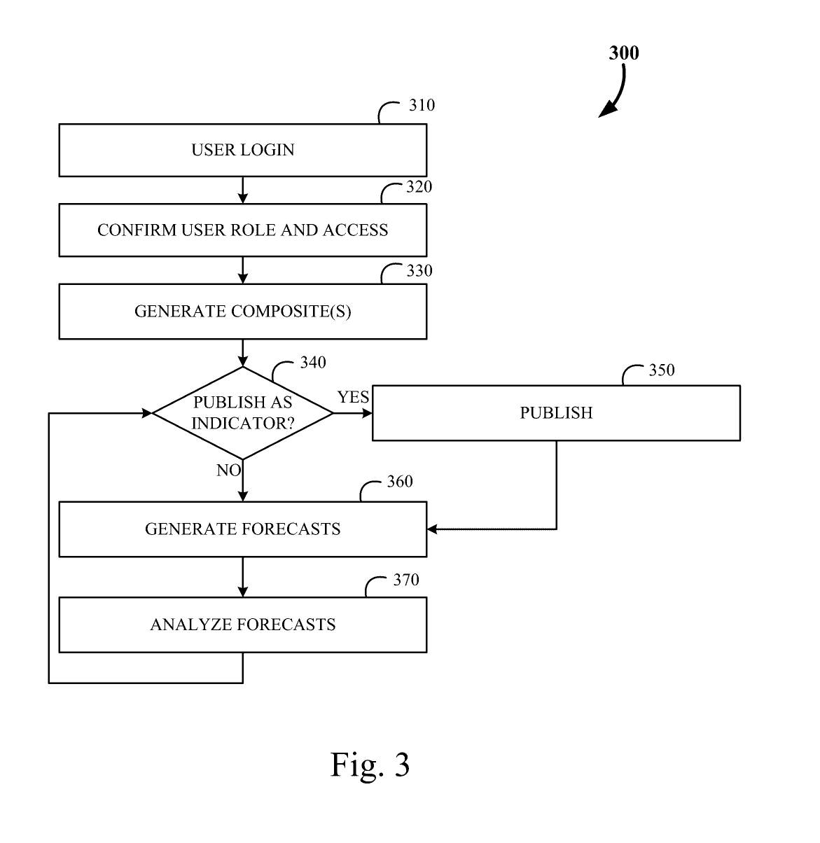

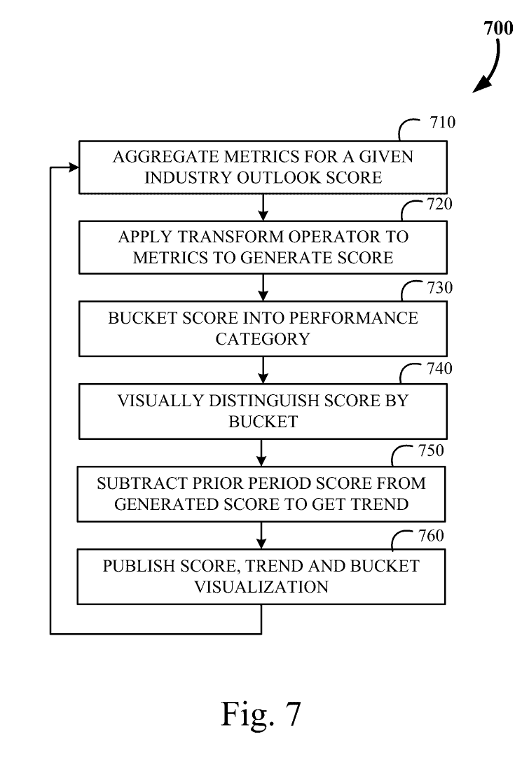

To facilitate the discussion, a series of flowcharts are provided. FIGS. 3-6 provide an overview of the composite building and forecast processes. FIG. 7 explores outlook score generation in greater detail. Fundamentally, outlook score generation is the production of a series of specialized composites and forecasts that provide for a normalized score across different industries, and a common time horizon for the forecast. Unlike the generic composite and forecasts discussed in FIGS. 3-6, these outlook scores are not subject to the same degree of user manipulation in order to maintain their functionality as comparable across industry segments and for a known time horizon.

FIG. 3 is a flow chart diagram of an example high level process 300 for forecasting utilizing time series datasets. In this example process, the user of the system initially logs in (at 310) using a user name and password combination, biometric identifier, physical or software key, or other suitable method for accessing the system with a defined user account. The user account enables proper access control to datasets to ensure that data is protected within an organization and between organizations.

The user role access is confirmed (at 320) and the user is able to search and manipulate appropriate datasets. This allows the user to generate composites (at 330) for enhanced analysis. As previously discussed, a composite is an entirely new dataset generated via the compilation, transformation and aggregation of existing indicator data sets.

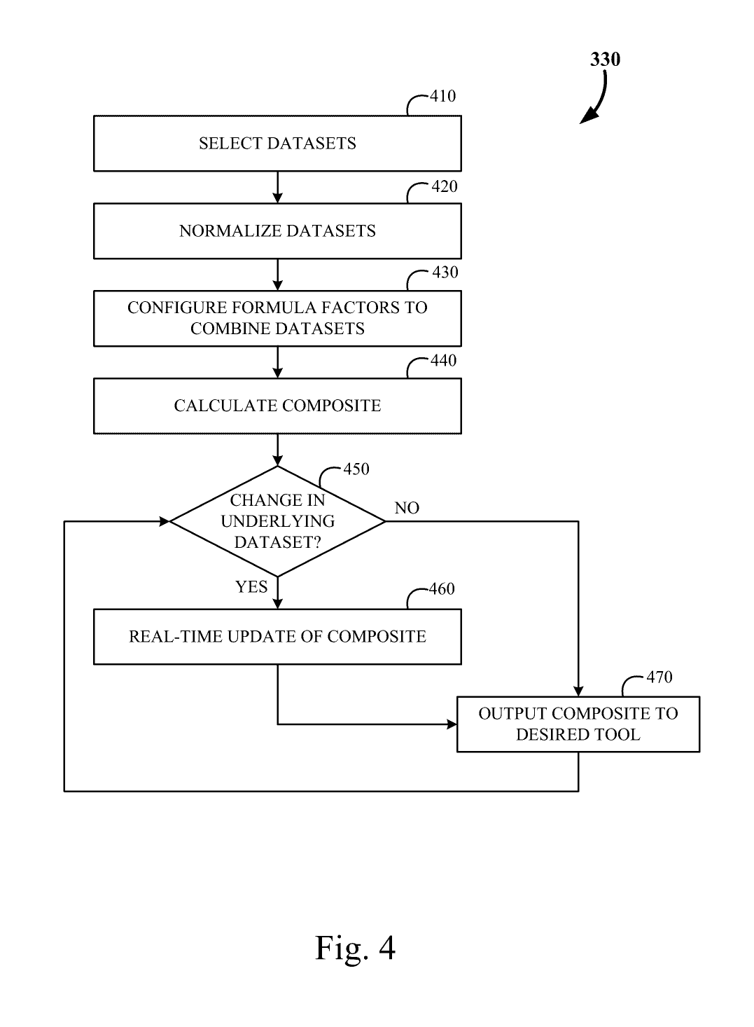

FIG. 4 provides a more detailed example high level process for the generation of composites. For composite generation, the user initially selects a dataset to be utilized (at 410). This selection may employ the user searching for a specific dataset using a keyword search. The datasets matching the keyword may be presented to the user for selection. In some embodiments, the search results may be ordered by best match to the keyword. In other embodiments, the search results may be ordered by alternate metrics, such as popularity of a given indicator (used in many other forecast models), accuracy of indicator data, frequency of indicator data being updated, or ‘fit’ between the indicator and the composite. Search results may further be sorted and filtered by certain characteristics of the data series, for instance, by region, industry, category, attribute, or the like. In some cases, search display may depend upon a weighted algorithm of any combination of the above factors.

A ‘fit’ between the composite and the indicator may be measured by the R², procyclic and/or countercyclic value when comparing the indicator to the composite. For example, if the composite is for domestic construction spend futures, indicators with a high degree of ‘fit’ may include stock prices for home improvement companies, number of building permit starts reported by the government, and raw material costs for concrete, lumber and steel, for example.

In addition to utilizing all or some of the above factors for displaying search results, some embodiments of the method may generate suggestions for indicators to the user independent of the search feature. Likewise, when a user selects an indicator, the system may be able to provide alternate recommendations of ‘better’ indicators based on any of the above factors.

Regardless of if an indicator is selected via a suggestion or a search, the next step is to normalize the datasets (at 420). This may include transforming all the datasets into a percent change over a given time period, an absolute dollar amount over a defined time period, or the like. Likewise, periods of time may also be normalized, such that the analysis window for all factors is equal. Next the user is able to configure a formula that takes each indicator and allows them to be combined (at 430). In some embodiments, this formula is freeform, allowing the user to tailor the formula however desired. In alternate embodiments, the formula configuration includes a set of discrete transformations, including providing each indicator with a weight, and allowing the indicators to be added/subtracted and/or multiplied or divided against any other single or group of indicators.

Once the formula has been configured, the system calculates the composite (at 440) and waits for a change in the underlying datasets (at 450). At any time the composite may be output for usage by another tool, such as a forecast (at 470), but upon a change to one of the indicators that comprises the composite, the method may cause a real-time update of the composite calculation (at 460). Any downstream tool the composite has been incorporated into will likewise receive an update.

Returning to FIG. 3, once composites have been generated, the method determines if it is desirable to publish the composite as an indicator (at 340) within the model library (as previously discussed). If so, then the composite is published (at 350) with appropriate access controls. Any access controls applied to the underlying datasets are automatically applied to the composite, in some embodiments, and further access controls may be enforced by the composite author as well.

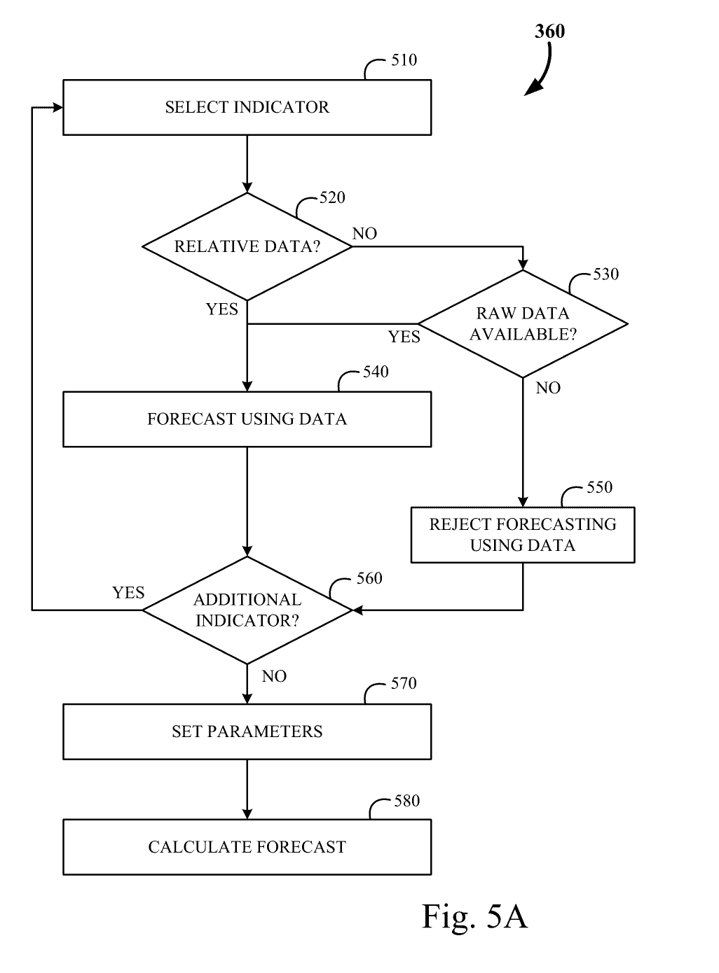

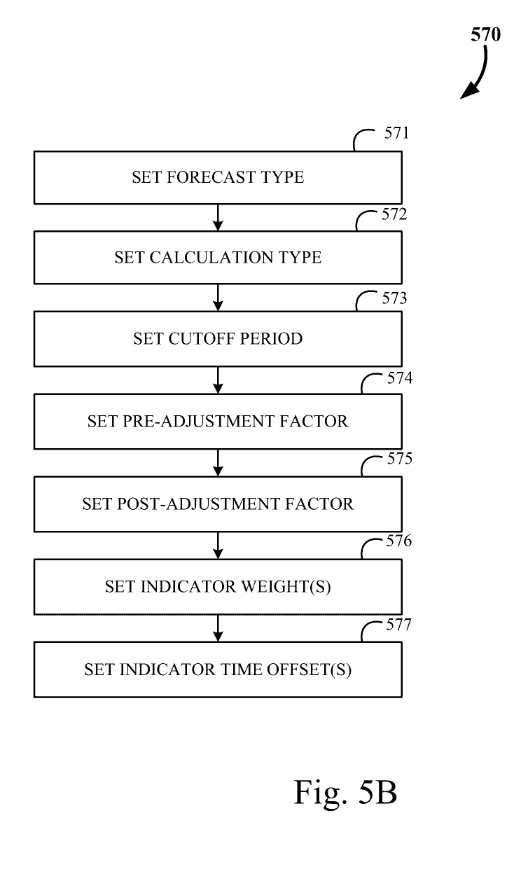

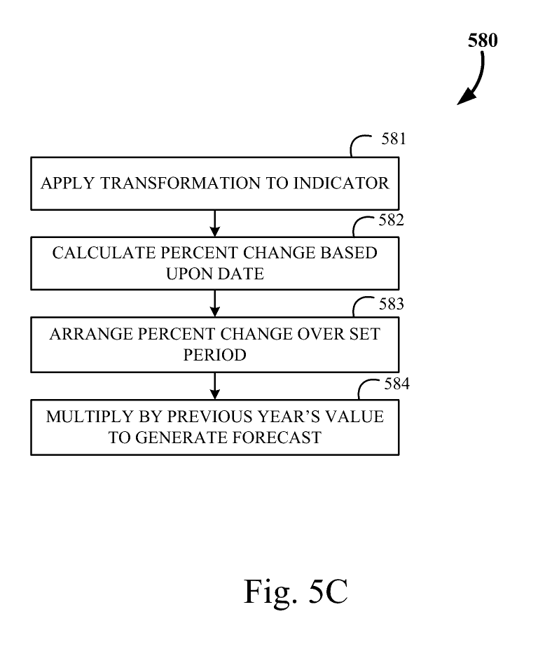

Next, a forecast may be generated (at 360), which is described in considerably more detail in reference to FIGS. 5A-5C. At FIG. 5A, the forecast generation process 360 initially begins with the selection of an indicator (at 510). This selection process may include searches or suggestions of indicators in much the same manner as described above in relation to the building of a composite. Again, the suggestion of an indicator (or display or search results, depending upon embodiment), may be driven by popularity of a given indicator, accuracy of indicator data, frequency of indicator data being updated, or ‘fit’ between the indicator and the forecast.

After the indicator has been selected, the system performs a check on whether the selected indicator is relative to the forecast (at 520). This step enables data that loses granularity, or becomes less accurate, upon transformation for the forecast, to be identified and either replaced or weeded out. For example, in some cases a set of revenue data may be needed to be converted into a year-over-year indicator. This aggregation may cause an artificial suppression of the indicator's value, and thus negatively impact the forecast. Such data is deemed not relative, and the method looks for whether raw data is available for the metric being sought (at 530). For example, maybe there is a metric for such year-over-year measure, or other revenue data of sufficient frequency that the system could generate such data without a loss of accuracy. If so, or if the original indicator selected is relative, then the method may forecast using the appropriate data (at 540). Otherwise, the method may outright reject the indicator as being included in the forecast (at 550). This may include an error message provided to the user explaining why the dataset is improper for the forecast.

This entire process may be repeated for additional indicators if they are present (at 560). This allows for forecasts that include as many indicators as a user desires. Once all indicators are selected, however, the method continues with the selection of parameters for the forecast (at 570). FIG. 5B provides more details regarding this example process 570 for selection of forecast parameters. Initially the forecast type is selected by the user (at 571). Forecast type may include segmented multivariate forecast, linear regression models, piecewise linear models, or the like. Additionally, the calculation type may be selected (at 572). Calculation types include year-over-year percent changes, month-over-month, three month moving averages, actual values, and the like.

Next the user selects the cutoff period for the forecast (at 573). Typically this is a time period in the future that provides the user with useful insight into business decisions, or other actions, that are to be taken in the near future. Many forecasts perform very well for some limited period of time, but then rapidly degrade. These forecast models, when viewed in the aggregate, are seen as very poor predictors. However, when subject to a cutoff period, these models may in fact be extremely high performing over the time period of concern. For this reason, the cutoff period is initially set in order to select the best forecast parameters and indicators over the period of interest.

Next pre-adjustment factors and post-adjustment factors are set (at 574 and 575, respectively). These factors are multipliers to the forecast and/or indicators that account for some anomaly in the data. For example, a major snowstorm impacting the eastern seaboard may have an exaggerated impact upon heating costs in the region. If the forecast is for global demand for heating oil, this unusual event may skew the final forecast. An adjustment factor may be leveraged in order to correct for such events.

Next, for each indicator, a weight and a time offset is provided (at 576 and 577, respectively). The weight may be any positive or negative number, and is a multiplier against the indicator to vary the influence of the indicator in the final model. A negative weight will reverse procyclic and countercyclic indicators. Determining whether an indicator relationship exists between two data series, as well as the nature and characteristics of such a relationship, if found, can be a very valuable tool. Armed with the knowledge, for example, that certain macroeconomic metrics are predictors of future internal metrics, business leaders can adjust internal processes and goals to increase productivity, profitability, and predictability. The time offset allows the user to move the time domain of any indicator relevant to the forecast. For example, in the above example of global heating oil, the global temperature may have a thirty day lag in reflecting in heating oil prices. In contrast, refining capacity versus crude supply may be a leading indicator of the heating oil prices. These two example indicators would be given different time offsets in order to refine the forecast.

For any forecast indicator, an R² value, procyclic value and countercyclic value is generated in real time for any given weight and time offset. These statistical measures enable the user to tailor their model according to their concerns. In some embodiments the weights and offsets for the indicators may be auto-populated by the method with suggested values. These values, as previously touched upon, may employ an optimization algorithm of weighted statistical measures. In some embodiment, the R² value, procyclic value and countercyclic values may be weighted and combined, and maximum value generated by a specific weight and offset can be suggested.

Returning to FIG. 5A, after the parameters have been set, the forecast is actually calculated (at 580). FIG. 5C details this example process 580 for calculating the forecast. Initially the indicators are transformed (at 581) according to the previously defined parameters. For example the indicator may be transformed into a common format such as year-over-year percent change. Next the percent change is determined for each date based upon the transformed indicators (at 582), and the percent change is arranged over the set period (at 583) defined by the cutoff period. Lastly, the previous year's value is multiplied by this percent change for each given date to generate the forward forecast (at 584). Forward forecasted indicators may then be weighted and offset according to the defined parameters. The forecasted indicators may also be summed and have the pre and post adjustments applied in order to generate the final forecast value.

Returning to FIG. 3, after the forecast has been generated, the forecast is subsequently analyzed (at 370). The process continues by determining if the forecast is to be published as an indicator. As previously mentioned, the published indicators may be access controlled for particular users, and may be incorporated into further forecasts.

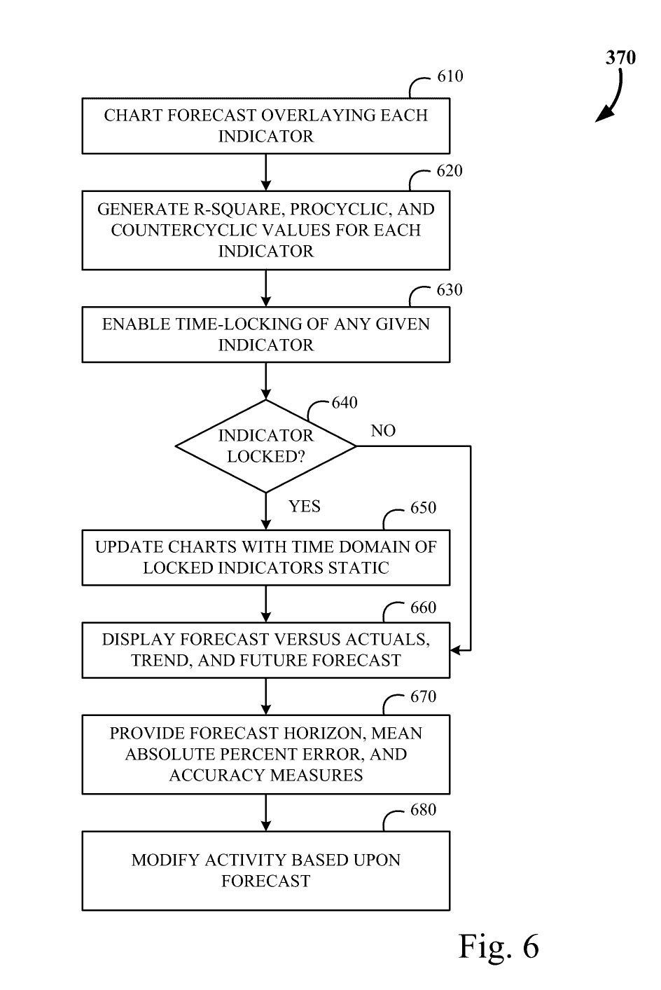

FIG. 6 provides further details regarding the example process 370 for the analysis of the forecasts. For the analysis, initially the forecast is charted overlying each indicator value (at 610). This charting allows a user to rapidly ascertain, using visual cues, the relationship between the forecast and each given metric. Humans are very visual, and being able to graphically identify trends is often much easier than using numerical data sets. In addition to the graphs, the R2, procyclic values, and countercyclic values may be presented (at 620) alongside the charted indicators.

Where the current method is particularly potent is its ability to rapidly shift the time domains, on the fly, of any of the indicators to determine the impact this has on the forecast. In some embodiments, one or more time domain outer bound drag bars may be utilized to alter the time domain of indicators. The time domain defining drag bar may be graphically manipulated by the user. Moving the drag bar will alter and redefine the time domain in which the selected metrics for a report are displayed. For example, in one situation a set of charts could display five metrics for the time period starting January 2006 and ending May 2012. By manipulating the drag bar, the time domain and thus the range of available data viewed in the report dashboard can be altered. In this example, the metrics are now displayed for the time period starting in March 2005 and ending in May 2012. Note that the entire time domain defining control may be graphically manipulated along a line, in some embodiments, where a lower and upper bound of the time domain are able to be manipulated, or the entire range may be merely shifted, thereby maintaining the same range, or length, of data represented.

Unique to the currently disclosed methods, however, is the ability to lock the time domain of any given indicator (at 630) such that if an indicator is locked (at 640) any changes to the time domain will only shift for non-locked indicators. Upon an shift in the time domain, the charts that are locked are kept static (at 650) as the other graphs are updated.

In addition to presenting the graphs comparing indicators to the forecast, in some embodiments, the forecast may be displayed versus actual values (for the past time period), trends for the forecast are likewise displayed, as well as the future forecast values (at 660). Forecast horizon, mean absolute percent error, and additional statistical accuracy measures for the forecast may also be provided (at 670). Lastly, the eventual purpose of the generation of the forecast is to modify user or organization behaviors (at 680).

Like the composite and forecast generation of FIGS. 3-6, the process disclosed in FIG. 7 likewise generates a forecast for a given industry for the ‘health’ over a set future period. This is known as the outlook score for the industry. As previously noted, this score may be a single number within a set range, and may indicate the health of the industry for a set number of months into the future. In some embodiments this score may be a value between 0 and 1000. In some embodiments, this score may be a measure of industry health expected in the next six month period.

By standardizing the range of the outlook scores, and the time horizon these scores operate over, the presently disclosed method allows for users to directly compare industries that are not related to one another. This may be very useful for fund managers and other investors. Likewise, it may provide businesses insights on where to market and target resources.

The first step in generating and industry outlook score is to aggregate the metrics that are employed in the generation of the metric for a given industry segment (at 710). The components utilized for each industry segment vary based upon which industry is being calculated for. As noted above, these components may include other indexes (such as the S&P 500), and other metrics (such as consumer sentiment).

After the pertinent underlying data has been accessed, a transform is applied to the data to generate the new outlook score for the industry (at 720). As previously noted, in some embodiments, the transform employed may include a number of steps including a volatility smoothing procedure, alignment of data by the same dates, classification of the components, determining month-to-month changes based upon component classification, adjusting to equalize volatility, generating growth rate index, summing the growth rates to equate trends to a coincidence index, computing the index with a symmetric percent change formula, rebasing the index to average 100, converting the index to a three period year over year percent change, and finally converting this to a normalized scale.

Next the outlook score generated for a given industry segment may be bucketed into a ‘health’ or performance category (at 730). This performance category may provide the user with a rapid understanding of the relative performance that should be expected from the industry over the following time period of interest. In some embodiments, the outlook score is linear, and may be segmented into equal sized ‘buckets’ indicating the industry's outlook. For example, a score between 0 and 250 may be considered poor, between 251 and 500 fair, between 501 and 750 good, and between 751 and 1000 excellent. In other embodiments, more granular classifications may be utilized. In yet other embodiments, the score may be non-linear, and the buckets may not be equal sized. For example, on a logarithmic scaled outlook score, the buckets could range from 1-50 for poor, 51-75 for fair, 76-90 for good, and 91-100 for excellent.

The next step in this example method is to visually distinguish the score based upon the ‘bucket’ it falls into (at 740). Again, the purpose of the outlook scores is to provide a user friendly mechanism to readily convey information regarding the health of an industry segment over a relatively short time horizon. By visually distinguishing the score by the bucket it falls under, the user may rapidly ascertain the general health of the industry with very little effort. This visual distinguishing may include any combination of color coordination, font selection, display location (such as on a number line style graphic), font sizing, or the like. Examples are provided below of how this visual distinguishing may be performed.

In addition to visually distinguishing the scores, it is also helpful to users to understand the shift in the score from the previous month (or however often the score is updated in any given embodiment). As such, the method next subtracts the prior period's outlook score from the score that has been newly generated (at 750). To yield a trend value. The trend value, raw score and bucket visualization may all be provided graphically to the user (at 760) to assist in the user's decision making processes, and ultimately in order to influence the user's behavior.

In some embodiments, modifying behaviors may be dependent upon the user to formulate and implement. In advanced embodiments, suggested behaviors based upon the outlook scores (such as commodity hedging, investment trends, or securing longer or shorter term contracts) may be automatically suggested to the user for implementation. In these embodiments, the system utilizes rules regarding the user, or organization, related to objectives or business goals. These rules/objectives are cross referenced against the outlook scores, and advanced machine learning algorithms may be employed in order to generate the resulting behavior modification suggestions. In some other embodiments, the user may configure state machines in order to leverage outlook scores to generate these behavior modification suggestions. Lastly, in even further advanced embodiments, in addition to the generation of these suggestions, the system may be further capable of acting upon the suggestions autonomously. In some of these embodiments, the user may configure a set of rules under which the system is capable of autonomous activity. For example, the outlook score may be required to have above a specific accuracy threshold, and the action may be limited to a specific dollar amount for example.

### III. EXAMPLES

Now that the systems and methods for generating industry outlook scores have been described in considerable detail, attention will be turned to a series of example screenshots of the systems and methods being employed. It should be noted however, that these example screenshots are but a limited set of embodiments presented for clarification purposes. As such, these example screenshots should not limit the scope of the presently disclosed invention in any way.

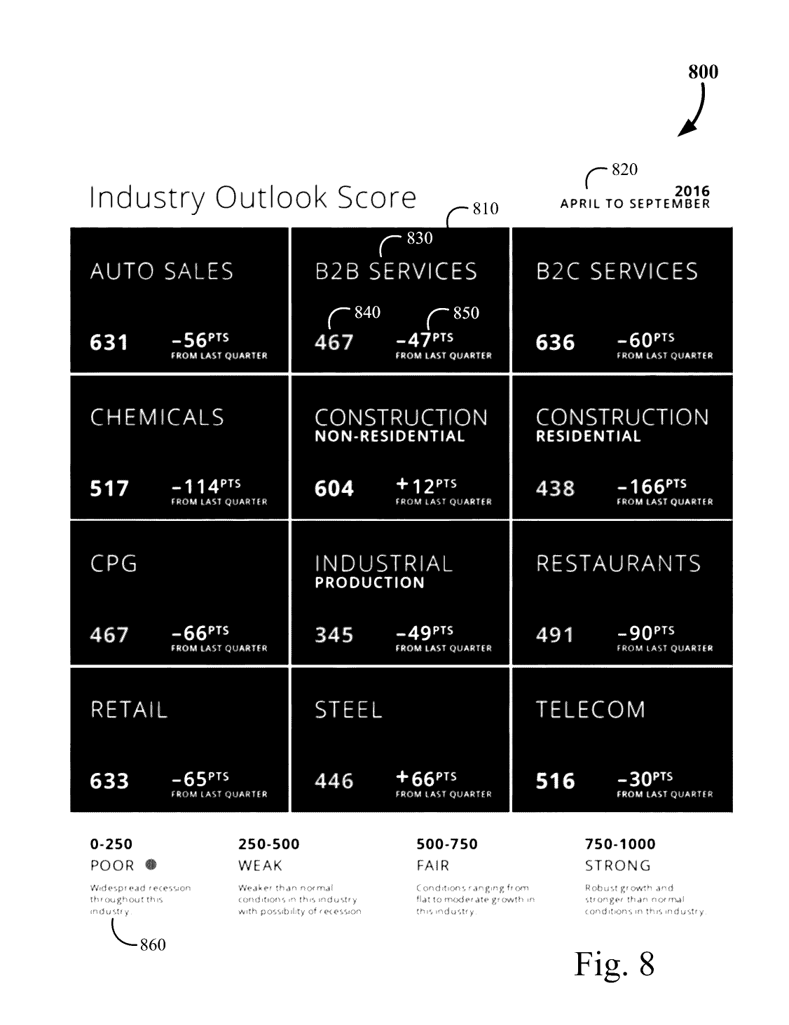

FIG. 8 provides a summary screenshot 800 of a series of industry outlook scores in a dashboard for exploration by a user. The time period for the outlook is provided (at 820) for the user. Each industry is labeled (at 830) and a color coordinated score is illustrated (at 840). The change in the score from the last period is likewise illustrated (at 850) to provide trend context to the user. The score ‘buckets’ that in this screenshot include a color visualization, are enumerated at the bottom of the interface (at 860). In this example the scores are broken into four categories: poor, weak, fair and strong. Alternate numbers, ranges and names for these score ‘buckets’ may likewise be employed.

Note, as previously discussed, the scores are all on a similar range (from 0-1000) and are for the same forecast period (here the second quarter of 2016). This enables direct comparison between the relative strength of entirely divergent industry sectors. For example, construction of non-residential structures is doing fairly well, whereas industrial production is doing relatively poorly. For an investor, these numbers could help determine which industry sectors to invest in. For a business with many operations, such information may help to allocate resources and efforts.

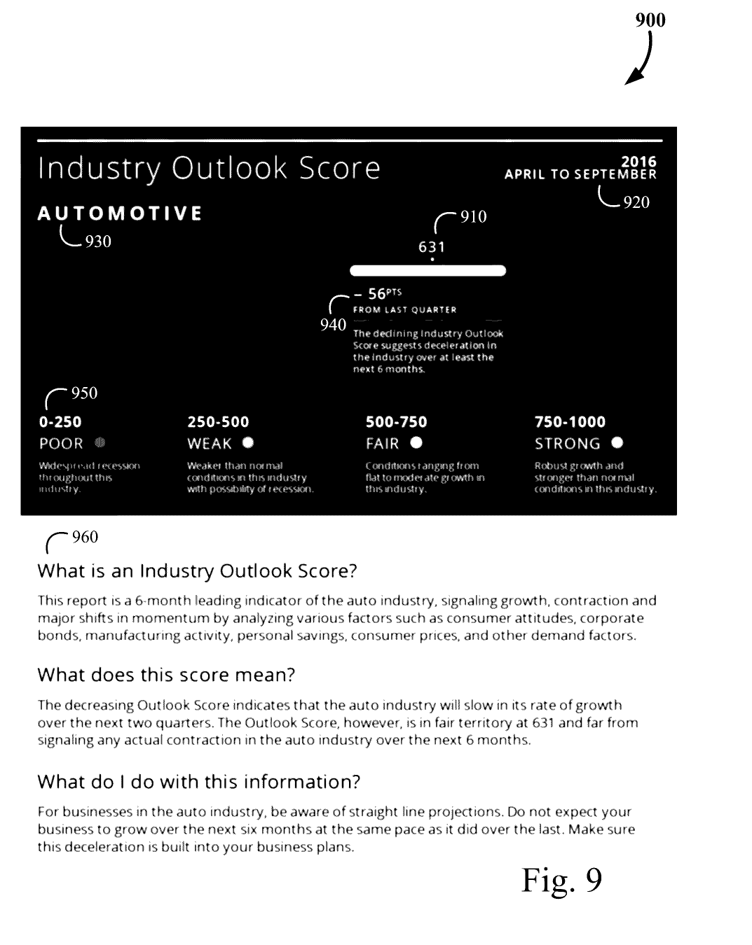

The user may dig deeper into any of the outlook scores by merely clicking on the relevant box. For example, if the user selects the automotive box, a new page may be displayed to the user, as seen at FIG. 9, with additional details regarding the outlook score for the industry of interest, shown generally at 900.

As with the summary page, the period for which the outlook score is forecasting is provided to the user (at 920). The specific industry segment being looked at is also identified (at 930). The outlook score is illustrated (at 910). In this example, the range of scores is illustrated as a series of color coded bars in a staggered number line. The outlook score is illustrated in the color of the bucket it falls into, and is positioned accordingly in the number line. Below the number line segment the score falls under is the trend number for the score (at 940) along with an explanation of what this may indicate. Again, the trend is determined by subtracting the prior outlook score form the current outlook score. Here the trend is downward, indicating a softening in the automotive market.

The buckets, with corresponding color coordination, are illustrated below the number line (at 950). Qualitative explanations of what these buckets mean are likewise provided. Further, a series of informational explanations are provided below (at 960). These explanations may be tailored by the score value, and by the industry segment. For example, in this screenshot, the explanation indicates that this score is a 6 month leading indicator for the auto industry. It further explains that the decreasing trend means that the auto industry growth will slow over the next two quarters, but that the score is still fair, suggesting that any slowed growth is still well insulated from a contraction in the sector. Lastly, advice is provided based upon the score.

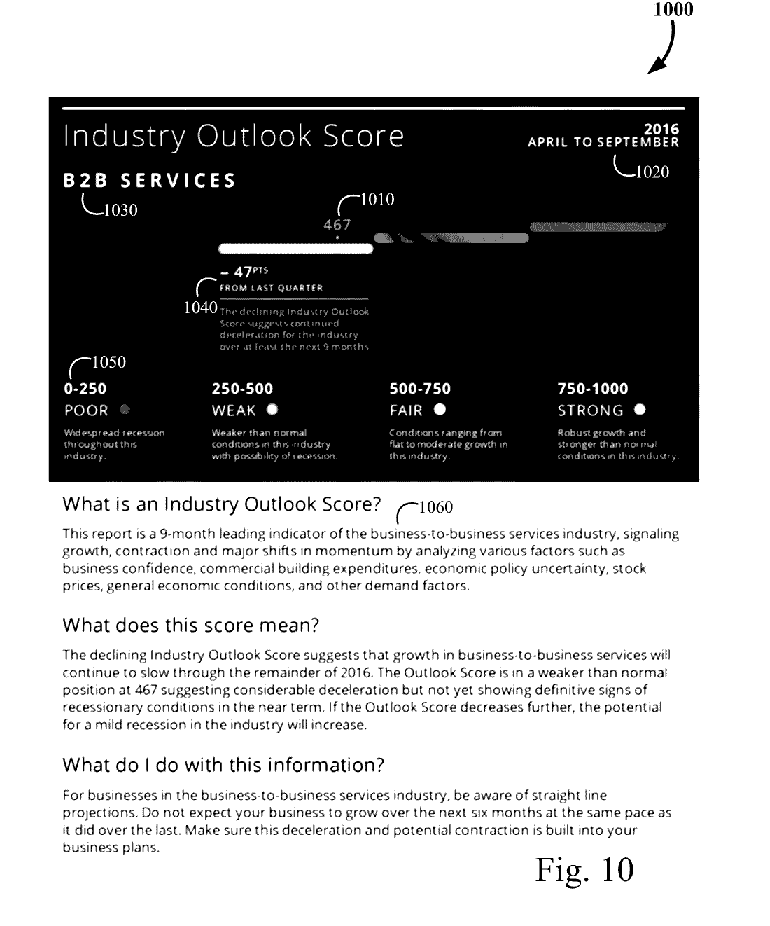

In contrast, FIG. 10 provides a detailed screenshot of an industry segment that is in worse shape than the automotive industry for comparison purposes, shown generally at 1000. As with the previous screenshot, the forecast period is illustrated (at 1020) as well as the industry name (here B2B services, at 1030). For this segment the outlook score is lower, and is positioned along the number line and colored accordingly (at 1010). The trend number is likewise illustrated (at 1040), as are captions regarding the buckets (at 1050).

Significantly, the explanations provided differ from the other industry outlook scores due to the differing score value, as well as the differences in the industry sector (as seen at 1060). Here the indicator is identified as a 9 month leading indicator, due in this example to the accuracy of the forecasts for this industry type. The explanation of the score indicates that there is considerable deceleration in this industry segment, but not necessarily recessionary conditions.

### IV. SYSTEM EMBODIMENTS

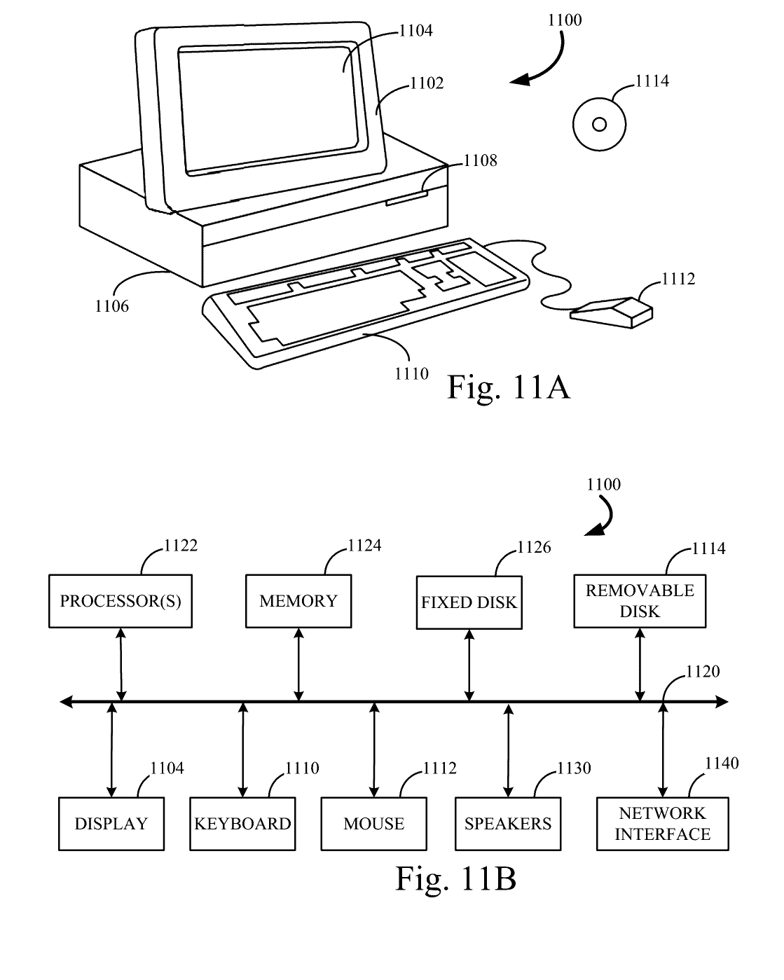

Now that the systems and methods for the generation of industry outlook scores have been described, attention shall now be focused upon systems capable of executing the above functions. To facilitate this discussion, FIGS. 11A and 11B illustrate a Computer System 1100, which is suitable for implementing embodiments of the present invention. FIG. 11A shows one possible physical form of the Computer System 1100. Of course, the Computer System 1100 may have many physical forms ranging from a printed circuit board, an integrated circuit, and a small handheld device up to a huge super computer. Computer system 1100 may include a Monitor 1102, a Display 1104, a Housing 1106, a Disk Drive 1108, a Keyboard 1110, and a Mouse 1112. Disk 1114 is a computer-readable medium used to transfer data to and from Computer System 1100.

FIG. 11B is an example of a block diagram for Computer System 1100. Attached to System Bus 1120 are a wide variety of subsystems. Processor(s) 1122 (also referred to as central processing units, or CPUs) are coupled to storage devices, including Memory 1124. Memory 1124 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Disk 1126 may also be coupled bi-directionally to the Processor 1122; it provides additional data storage capacity and may also include any of the computer-readable media described below. Fixed Disk 1126 may be used to store programs, data, and the like and is typically a secondary storage medium (such as a hard disk) that is slower than primary storage. It will be appreciated that the information retained within Fixed Disk 1126 may, in appropriate cases, be incorporated in standard fashion as virtual memory in Memory 1124. Removable Disk 1114 may take the form of any of the computer-readable media described below.

Processor 1122 is also coupled to a variety of input/output devices, such as Display 1104, Keyboard 1110, Mouse 1112 and Speakers 1130. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 1122 optionally may be coupled to another computer or telecommunications network using Network Interface 1140. With such a Network Interface 1140, it is contemplated that the Processor 1122 might receive information from the network, or might output information to the network in the course of performing the above-described generation of industry outlook scores. Furthermore, method embodiments of the present invention may execute solely upon Processor 1122 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 1100 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer, and when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method for generating industry outlook scores, useful in association with a forecasting engine, the method comprising:
determining industry for which an outlook score is desired;
receiving selected datasets for the determined industry;
normalizing the selected datasets;
generating an outlook score for the industry by transforming the datasets by a macro formula;
subtracting a prior outlook score from the generated outlook score to determine a trend;
characterizing the generated outlook score; and
displaying the generated outlook score, trend and characterization.

2. The method of claim 1 wherein the normalizing includes:
smoothing volatility from the elected datasets;
aligning the datasets by similar dates;
classifying the datasets as normal, inverted or diffusion;
determining month-to-month change of each dataset based upon the classification; and
adjusting to equalize volatility between datasets.

3. The method of claim 2 wherein the macro formula includes:
generating a growth rate index;
summing the growth rates to equate trends to a coincidence index;
computing an index with a symmetric percent change formula;
rebasing the index to average 100;
converting the index to a three period year over year percent change; and
converting the three period year over year percent change to a normalized scale.

4. The method of claim 2 wherein the smoothing volatility from the elected datasets utilizes a Hodrick Prescott filter.

5. The method of claim 3 wherein the normal classified datasets are procyclic to the index, the inverse classified datasets are counter-cyclic to the index, and the diffusion classified datasets are measures of the proportion of the dataset that are positive impacts on the index.

6. The method of claim 5 wherein:
determining month-to-month change of normal classified datasets is calculated by:
$$x ( t ) = 200 \frac{( {x}_{t} - {x}_{t - 1} )}{( {x}_{t} + {x}_{t - 1} )}$$
determining month-to-month change of inverse classified datasets is calculated by:
$$x ( t ) = 200 \frac{( {x}_{t - 1} - {x}_{t} )}{( {x}_{t} + {x}_{t - 1} )}$$
and, determining month-to-month change of diffusion classified datasets equals monthly levels.

7. The method of claim 1 wherein the selected datasets include at least three of residential architectural billings index, consumer sentiment scores, ISM manufacturing index of new orders, Moody's Seasoned Aaa Corporate bond yield, personal savings rate, consumer price index for urban consumers, commercial architectural billings index, Cass Freight index of expenditures, economic policy uncertainty index for the United States, NFIB small business optimism index, United States Non-Manufacturing Business Tendency Survey: Business Situation and Activity, an adjusted S&P 500 score, ISM manufacturing index of new orders, industrial production and capacity utilization rate for chemicals, architectural billings index for new projects inquiries, real average hourly earnings, producer price index for chemical manufacturing, an adjusted materials select sector index, S&P Case-Shiller 10-City home price sales pair count, average weekly hours of production employees in the chemical sector, ISM PMI composite, an adjusted J&J stock price, S&P Case-Shiller 10-City home sales arima 2, Prevedere retail leading indicator composite, Prevedere industrial production leading indicator composite, Prevedere residential construction leading indicator composite, NFIB small business optimism index, Bank of America Merrill Lynch US corporate AAA option adjusted spread, real personal consumption expenditures for durable goods, an adjusted score of American Express Company stock price, value of manufacturers' new orders for durable goods for the electrical equipment industry, total business sales, commercial paper outstanding, construction employment, S&P Case-Shiller 20-City home price sales pair count, new homes sold in the United States, assets and liabilities of commercial banks in the United States, forecasts of non-farm job openings, real disposable personal income, food service spread, adjusted consumer discrete select sector SPDR, personal savings rates, a volatility measure of the S&P 500, non-branch merchant wholesalers durable goods inventory to sales ratio, an adjusted United States Steel Corporation stock price, value of manufacturers' new orders for durable goods for iron and steel mills, and the value of manufacturers' new orders for the communication equipment industries.

8. The method of claim 3 wherein the converting the three period year over year percent change to the normalized scale includes setting the minimum value of the three period year over year percent change to zero and the maximum value of the three period year over year percent change to 1000 on a linear scale.

9. The method of claim 1 wherein the characterizing the generated outlook score includes segregating the score into linear quartiles.

10. The method of claim 9 wherein the characterizing the generated outlook score includes coloring the graphical representation of the score according to quartile.

11. A industry outlook score generator, useful in association with a forecasting engine, the system comprising:
a user interface for receiving input to determine industry for which an outlook score is desired;
a database for receiving selected datasets for the determined industry;
a processor for normalizing the selected datasets, generating an outlook score for the industry by transforming the datasets by a macro formula, subtracting a prior outlook score from the generated outlook score to determine a trend, and characterizing the generated outlook score; and
the user interface further able to display the generated outlook score, trend and characterization.

12. The system of claim 11 wherein the processor is configured to normalize the datasets by:
smoothing volatility from the elected datasets;
aligning the datasets by similar dates;
classifying the datasets as normal, inverted or diffusion;
determining month-to-month change of each dataset based upon the classification; and
adjusting to equalize volatility between datasets.

13. The system of claim 12 wherein the processor is configured to generate the outlook score by:
generating a growth rate index;
summing the growth rates to equate trends to a coincidence index;
computing an index with a symmetric percent change formula;
rebasing the index to average 100;
converting the index to a three period year over year percent change; and
converting the three period year over year percent change to a normalized scale.

14. The system of claim 12 wherein the processor is configured to smooth volatility from the elected datasets utilizing a Hodrick Prescott filter.

15. The system of claim 13 wherein the normal classified datasets are procyclic to the index, the inverse classified datasets are counter-cyclic to the index, and the diffusion classified datasets are measures of the proportion of the dataset that are positive impacts on the index.

16. The system of claim 15 wherein the processor:
determines month-to-month change of normal classified datasets is calculated by:
$$x ( t ) = 200 \frac{( {x}_{t} - {x}_{t - 1} )}{( {x}_{t} + {x}_{t - 1} )}$$
determines month-to-month change of inverse classified datasets is calculated by:
$$x ( t ) = 200 \frac{( {x}_{t - 1} - {x}_{t} )}{( {x}_{t} + {x}_{t - 1} )}$$
and, determines month-to-month change of diffusion classified datasets equals monthly levels.

17. The system of claim 11 wherein the selected datasets include at least three of residential architectural billings index, consumer sentiment scores, ISM manufacturing index of new orders, Moody's Seasoned Aaa Corporate bond yield, personal savings rate, consumer price index for urban consumers, commercial architectural billings index, Cass Freight index of expenditures, economic policy uncertainty index for the United States, NFIB small business optimism index, United States Non-Manufacturing Business Tendency Survey: Business Situation and Activity, an adjusted S&P 500 score, ISM manufacturing index of new orders, industrial production and capacity utilization rate for chemicals, architectural billings index for new projects inquiries, real average hourly earnings, producer price index for chemical manufacturing, an adjusted materials select sector index, S&P Case-Shiller 10-City home price sales pair count, average weekly hours of production employees in the chemical sector, ISM PMI composite, an adjusted J&J stock price, S&P Case-Shiller 10-City home sales arima 2, Prevedere retail leading indicator composite, Prevedere industrial production leading indicator composite, Prevedere residential construction leading indicator composite, NFIB small business optimism index, Bank of America Merrill Lynch US corporate AAA option adjusted spread, real personal consumption expenditures for durable goods, an adjusted score of American Express Company stock price, value of manufacturers' new orders for durable goods for the electrical equipment industry, total business sales, commercial paper outstanding, construction employment, S&P Case-Shiller 20-City home price sales pair count, new homes sold in the United States, assets and liabilities of commercial banks in the United States, forecasts of non-farm job openings, real disposable personal income, food service spread, adjusted consumer discrete select sector SPDR, personal savings rates, a volatility measure of the S&P 500, non-branch merchant wholesalers durable goods inventory to sales ratio, an adjusted United States Steel Corporation stock price, value of manufacturers' new orders for durable goods for iron and steel mills, and the value of manufacturers' new orders for the communication equipment industries.

18. The system of claim 13 wherein the processor converts the three period year over year percent change to the normalized scale by setting the minimum value of the three period year over year percent change to zero and the maximum value of the three period year over year percent change to 1000 on a linear scale.

19. The system of claim 11 wherein the processor characterizes the generated outlook score by segregating the score into linear quartiles.

20. The system of claim 19 wherein the processor characterizes the generated outlook score by coloring the graphical representation of the score according to quartile.
